(19) United States
(12) Patent Application Publication
(10) Pub. No.: US 2005/0289163 A1
(43) Pub. Date: Dec. 29, 2005

(54) Occasion for media objects

(76) Inventors: Eric Gordon, Boston, MA (US); Chris Gilman, Santa Monica, CA (US); Victor Lacour, Los Angeles, CA (US)

Correspondence Address: FISH & RICHARDSON, PC, 12390 EL CAMINO REAL, SAN DIEGO, CA, 92130-2081, US

(21) Appl. No.: 11/145,531

(22) Filed: Jun. 3, 2005

Related U.S. Application Data
(60) Provisional application No. 60/576,553, filed on Jun. 3, 2004.

(51) Int. Cl. G06F 7/00

(52) U.S. Cl. 707/100

(57) ABSTRACT

A media database which stores media of various types including movies, still images, and sounds, along with user comments about the media and links to other media. The user comments and links collectively form a composition about the media clip that others can view.

This application claims priority under 35 USC §119(e) to U.S. Patent Application Ser. No. 60/576,553, filed on Jun. 3, 2004, the entire contents of which are hereby incorporated by reference.

### BACKGROUND

Many different kinds of media objects are known. For example, media objects may include animation objects, such as video and film objects, sound objects such as music or speech objects, as well as still image objects. As the size of hard drives increase, correspondingly, the management of these objects may become more challenging.

Web based systems for managing, sharing and annotating digital media are known. One such system is available from blackboard Inc., called the blackboard content system. This may be used in conjunction with the blackboard learning system. The intent of this system is that it runs on the server of an institution, for example a university's, existing network system. A Web browser interface is used to allow access to the content. The system uses a virtual hard drive where different persons can store and share their personal content as well as access content. The content is intended to be content from a classroom which is part of the university. In addition, however, the content may include content from associated libraries, profile information, as well as a search function that allows locating media in the system.

Another system is Macromedia Breeze, which is a media organization system that is intended for corporate and educational presentations. This system may add audio commentary to visual slideshows.

Flikr is a photo-blogging software which allows users to upload photo collections with an option of making them private or public. If made public, they can be viewed and commented on by any site visitor. Photographs can be brought into “favorite” folders and added to personal collections. The meta-data for each photo expands as it is viewed and annotated—to form a “collaborative organizing of photos.”

Flikr is powered by the Technorati search engine (technorati.com). This engine searches through the content and tags of blogs and brings up all referencing blogs.

### SUMMARY

The present application describes a network-capable database application for the collective exploration, combination and manipulation of media objects. Media objects may include, but are not limited to, video/animated objects, music/sound objects, 3-D objects, and still image objects. One application of this system is for use in an academic class setting. An embodiment describes using a set of built-in digital authoring tools, including cut, copy, paste, crop, rotate, opacity, background color, text input, move to front/back, users can create multimedia compositions with media objects entered into the system by any user. Compositions can be comprised of multiple screens and text of varying size, color and font. Compositions can be read and responded to by other users through the creation of new compositions. Media objects and compositions can be traced through complex tagging and search functions.

### BRIEF DESCRIPTION OF THE DRAWINGS

These and other aspects will now be described in detail with reference to the accompanying drawings, wherein:

FIG. 1 shows a block diagram of the database application;

FIG. 2 shows a flowchart of data management;

FIG. 3 illustrates the database operation; and specific user interface screens.

FIG. 4 shows an exemplary screenshot of the application in use.

FIG. 5 shows an exemplary screenshot of the application in use.

FIG. 6 also shows an exemplary screenshot of the application in use.

### DETAILED DESCRIPTION

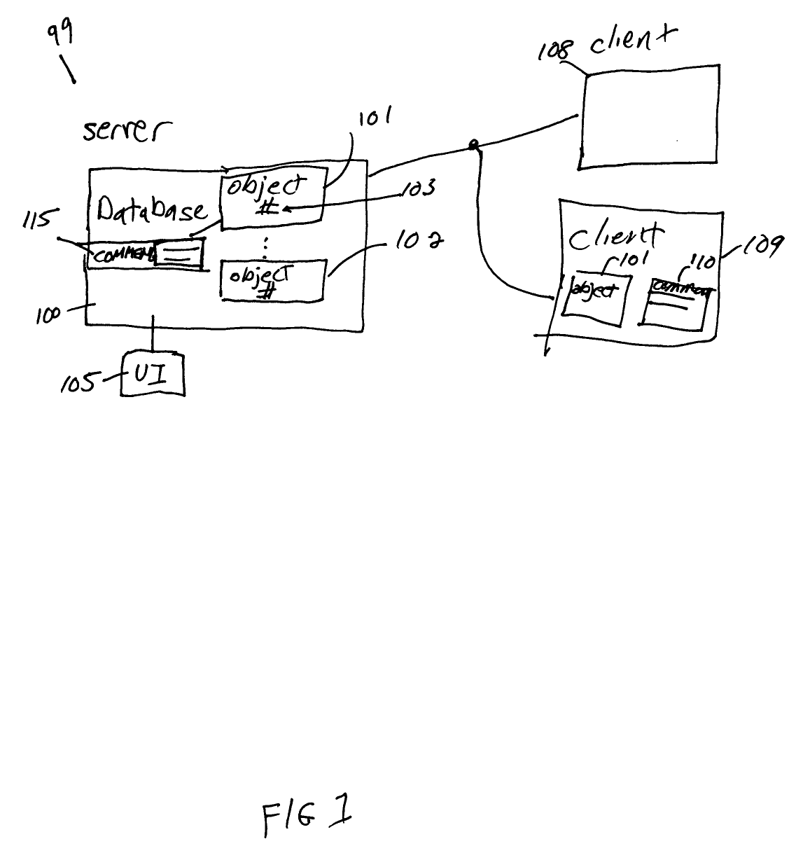

FIG. 1 shows a server 99 with database 100. The database 100 stores a number of different media objects, shown as 101, 102. Each object includes both the object itself, as well as a unique identifier 103 associated with the object. The objects in the database can be explored either locally, via the user interface 105, or remotely, from one of a plurality of clients shown as 108, 109, with it being understood that any number of clients can analogously be connected. Users can enter compositions about the object, which are effectively a collection of comments and links by a collection of users, about the object. The composition user interface 110 is shown as allowing entry of text information associated with the object 101. The composition can be of any type—for example, the composition can itself be another object, or can be sound or any other information associated with the object 101.

Once finalized, the composition is associated with the object, within the database. For example, a composition database 115 is shown within the database 100, the composition database 115 having comments that are associated with each of the objects. Other users may comment on the composition itself, or on other composition.

These commentaries cluster into discussions about the content, effectively multimedia compositions about the content. The media is thereby linked through the associations made by searching for related comments on the media objects. Each person who views an object can enter the dialogue, thereby providing a collective dialogue about the collection of media.

One application of this system is for use as an academic tool. However, alternatively, this system may be used for other organizations which store content; including museums, cultural centers, community centers, religious institutions, and businesses.

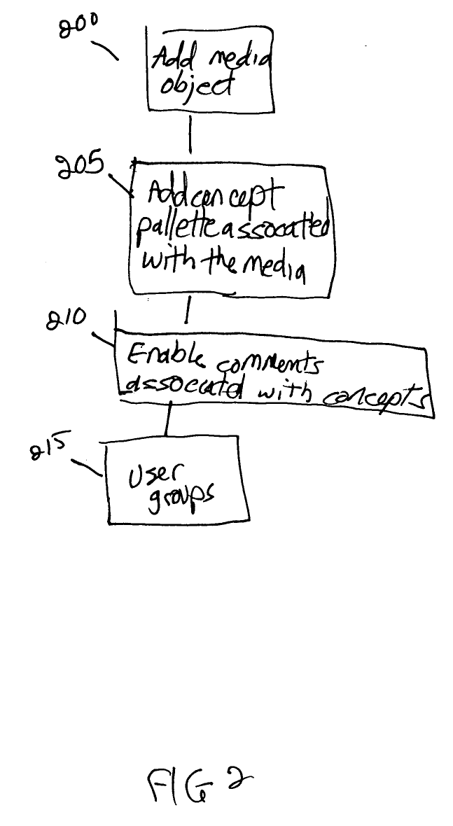

The operation of data management and comment is illustrated with reference to the flowchart of FIG. 2. The system as employed uses an special kind of data management scheme. This scheme allows the storage and retrieval of media objects and commentary. Moreover, this scheme allows changing of usage patterns over time.

A media object is added at 200. A user, e.g., the person who adds the media object, or an administrator, may associate a set of key notions forming a concept palette at 205. Users of the database must assign at least one preloaded concept to every composition. Media objects included in a composition are automatically associated with each other. Compositions may also include direct links to other compositions. Through these links and associations, data will cluster around key notions.

The box labeled “215” illustrates the concept of user groups. Different groups of users may have different viewpoints on the same media. Therefore, the user groups may each get their own individual concept palette, with different user groups having different concept palettes. Users may see how others in their own group have treated objects, as well as how others in other groups have said treated objects. This further defines the clustering of the information about the media object.

While multiple user groups can share a single collection of media objects, each user group may create its own set of comments and associations around the single concept palette. Different user groups can be assigned. For example, a first user group may have a first concept palette. The concept palette for that user group is used as a way to highlight the different possibilities for clustering the media objects.

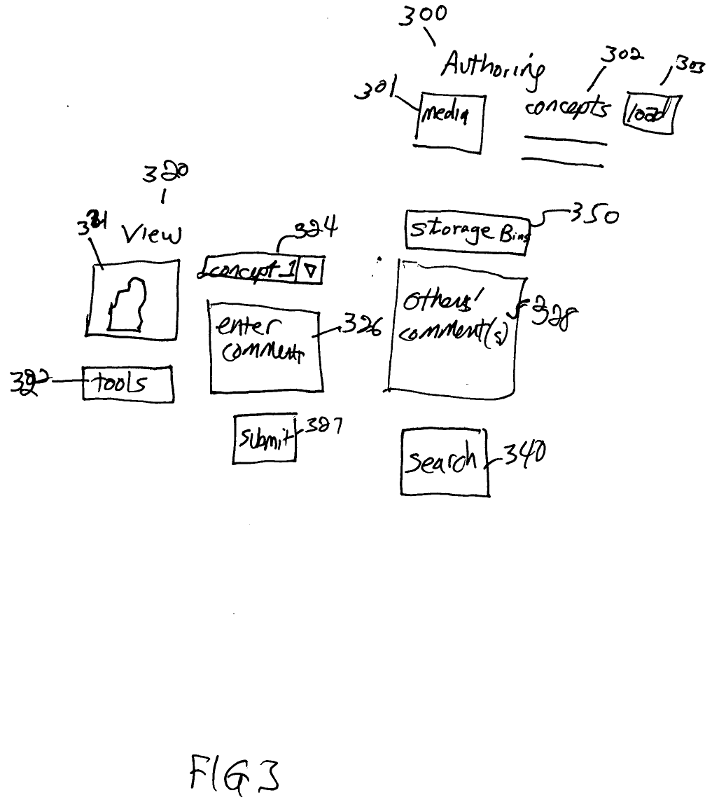

FIG. 3 shows a detailed diagram of the different features of the system. The system may be a local server database application, which can interface with a number of different clients. The screens and tools which are shown in FIG. 3 can be accessed either locally from the user interface 105, or remotely from any of the client.

300 shows an object import system, which allows the user to import a wide variety of media types. As part of the import process, the application prompts users to provide relevant fields of “metadata,” such as author, title, date, etc. according to the media type. As an example, the media types can include videos of various types: both compressed and uncompressed, still images of various types, 3-D renderings, sounds, as well as text and other media types. The media 301 can be uploaded, for example by drag and drop. The tool shows a thumbnail, for example, of the media which has been uploaded.

Concepts feature 302 can be used to author concept labels that effectively form text based labels. These create a concept palette that partially tags the data for concept-grouping results.

The viewing screen, shown as 320, is a multimedia platform presentation that allows for viewing and manipulation of multiple media objects. A toggle function on the viewscreen allows users to alternate between view and compose modes. A single view area 321 is shown. An image tools area 322 is also shown, which has tools for the image including functions such as move, resize, flip, crop and other functions such as opacity change and background color. The users can assemble the objects, with textual annotations, to create compositions. Compositions can be formed of a single screen or multiple screens. Concepts are shown in 324. Each composition requires at least one concept. Concepts are selected from the pre-loaded concept palette as shown in area 326. Descriptions of concepts can be made available by rolling over the concept label.

Multiple media types can coexist within the viewer. This can house video playback, viewing of pictures, viewing of 3-D objects, as well as viewing of sound type icons, all within the same virtual space. Any user with appropriate permissions can view a composition 301, and can publish a composition to the system in response. The application provides several ways for a user to respond to a composition. One option is to copy individual media objects, groups of media objects, whole screens or entire multi-screen compositions into the user's own composition in progress. Objects copied into a new composition by either of these means retain the edits and placement of the previous author. Another option allows establishing a link to a previous composition by clicking the “link” button or dragging that composition's thumbnail icon into a designated bin in the compose screen. Typically the user will then select one or more concepts from the concept palette, and enter comments regarding that concept, followed by submitting by clicking the publish button 327. The full composition is then transmitted into the database 100, along with markers indicative of the specific media about which the concepts are associated. Box 328 is for other's comments.

Another aspect of this system is that the object and text can be arranged into slideshow style sequences, and may be associated with image characteristics, for example position, size, opacity and textual commentary data. However, the manipulations of media objects are recorded as markers associated with a given object, and do not affect the media objects themselves. While viewing a composition, the user may select an embedded object and no matter how much it has been manipulated, it will appear in its original form in the object view screen as shown.

A search function is shown as 340. This may be used at any point during the commentary. The user may use the search function to get suggestions about additional media objects to be associated with the current media object. The user may also seek opinions of others that are within the user community about one or more of the objects in the viewing screen. The search button recalls a ranked thumbnail list of media objects that are related by previous users to the currently-viewed item, as well as concepts that are displayed. The search also provides past commentaries associated with these objects. A thumbnail can be dragged directly into the viewing screen to view the media object or to put it in the present commentary which has not been completed. The user can alternatively click on or drag an for a published commentary into the read screen in order to view it. Associations between media objects and commentaries were established when previous users created entries that formed relationships between those media objects. Because of the web-based solution, all media objects and commentary can be shared by all users within a defined community on the server.

The box labeled as “350” shows storage bins, that allow the user to store media objects and entries that are relevant to the class for student's curriculum or interest. This may also be used to house the items for later presentation.

This system may allow, when used as part of educational system, students to investigate history of media, explore the media, as well as see what others have said about the media. Categories such as discipline, medium, rhetoric and formal components may be investigated. For example, a user can pull up a painting as well as a piece of music, and see how the aspects of those two things are related. Since students professors and researchers can offer their own content and provide hypothetical relationships, this provides a discussion interface that allows official content as well as unofficial content to the media aspect.

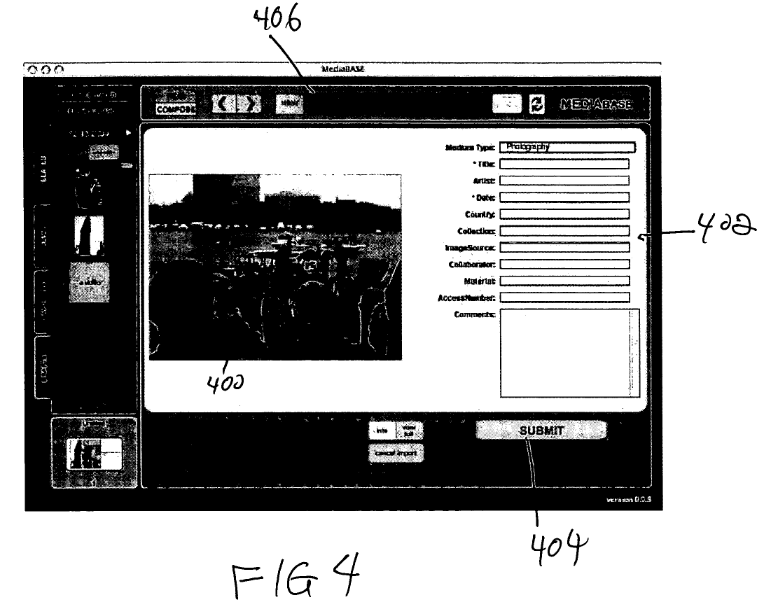

FIGS. 4-6 show some example screenshots of the application in use. FIG. 4 shows an exemplary authoring screen, which shows the media 400, as well as identifying information 402 about the media. The information includes media type; title; artist; date; country; collection; image source; collaborator; material; access number; and comments. The user can execute the submit button 404, to allow submission of the media and its associated information. Other functions can also be carried out on the picture, for example, image processing buttons 406 can be used to crop, rotate, color and carry out other conventional operations on the media.

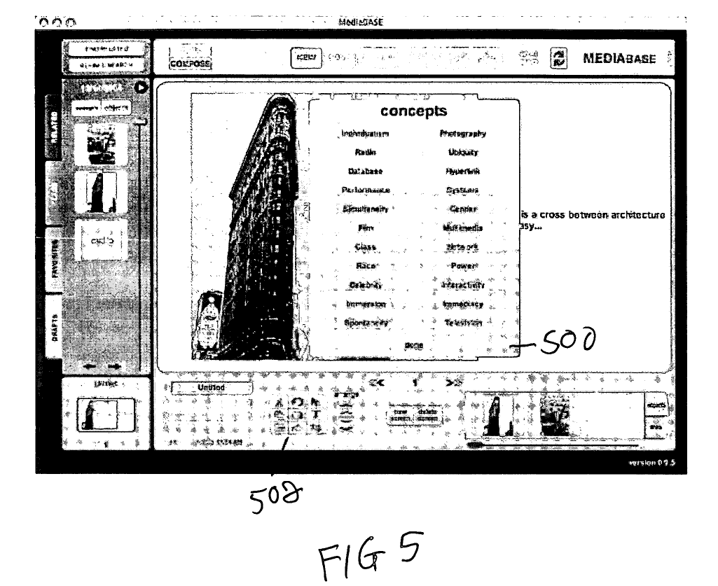

FIG. 5 shows the concept palette 500 portion of the authoring. The concept palette may allow a user to select different concepts; for example as shown here as individualism, radio, database, performance, simultaneity, film, class, race, celebrity, immersion, spontaneity, photography, ubiquity, hyperlink, systems, gender, multimedia, network, power, interactivity, immediacy, or television. The user can select one of these concepts, either to associate that concept with the media, or to add to the compositions to the media, based on those concepts. Again, the image processing buttons 502 allow changing the media as part of the authoring.

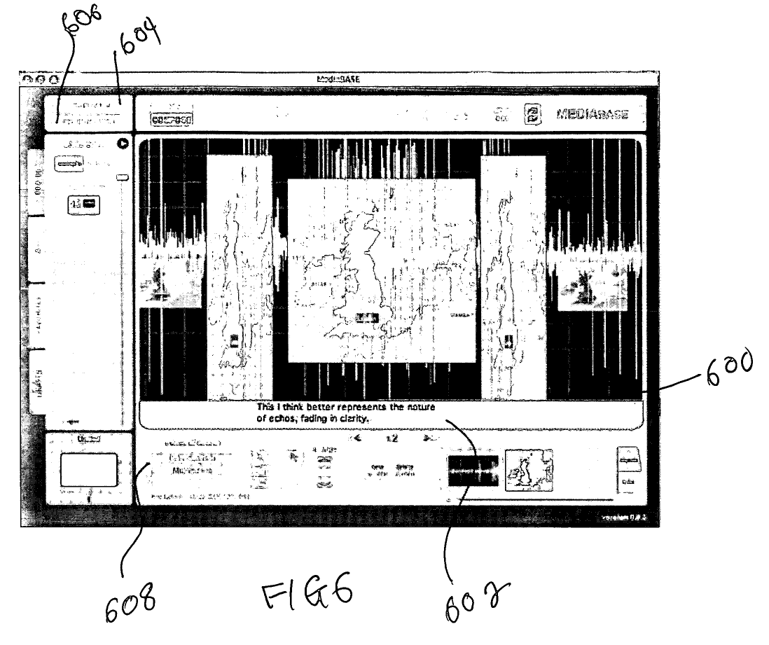

FIG. 6 illustrates the viewing screen, and shows how the media 600 can be associated with user comments 602. The user can make a comment such as their idea of what the media represents, and associate that comment with the image. As part of the reading, this may also search for related media by using the search button 604, and refine search at 606. Different concepts from the concept palette are shown as 608, here individualism and multimedia, allowing a user to comment on either of these aspects.

Although only a few embodiments have been disclosed in detail above, other modifications are possible, and this disclosure is intended to cover all such modifications, and most particularly, any modification which might be predictable to a person having ordinary skill in the art. For example, the above has described text comments, but it should be understood that other media may be used as comments, for example, as non verbal communications on the object.

Also, only those claims which use the words “means for” are intended to be interpreted under 35 USC 112, sixth paragraph. Moreover, no limitations from the specification are intended to be read into any claims, unless those limitations are expressly included in the claims.

1. A method, comprising:
forming a database of digital, computer-based media, each item of media having an identifier associated therewith; and
enabling each of a plurality of viewers from a plurality of separated clients to view said media and enabling each of said plurality of viewers to provide comments on said media, and links between different items of said media collectively forming a composition relating to said media, and also enabling each of said plurality of viewers to view said compositions associated with said media.

2. A method as in claim 1, wherein said database includes specified categories associated with each of certain media, and said comments are associated with said categories.

3. A method as in claim 2, further comprising defining a plurality of user groups, and defining a first set of categories with the first user group for said media, and the second set of categories for said user group for the same said media.

4. A method as in claim 3, wherein users within one user group can use separately comments provided by users in the same user group and provided by users in a different user group.

5. A method as in claim 1, wherein said comments are associated with at least one of a plurality of categories associated with said media, said categories collectively forming a concept palette.

6. An apparatus, comprising:
A server computer, storing a database of digital, computer-based media, and storing a plurality of identifiers, respectively associated with said database of media, said server computer forming a user interface which enables each of a plurality of viewers from a plurality of separated client computers to view said media from said database, and to provide comments on said media, and links between different items of said media to collectively forming a composition relating to said media, and also enabling each of said plurality of viewers to view said compositions associated with said media.

7. An apparatus as in claim 6, wherein said database includes specified categories associated with each of certain media, and said comments are associated with said categories.

8. An apparatus as in claim 7, wherein said database includes a definition of a plurality of user groups, including a first set of categories with a first user group for said media, and a second set of categories for said user group for the same said media.

9. An apparatus as in claim 8, wherein users within one user group can use separately comments provided by users in the same user group and provided by users in a different user group.
